(19) United States
(12) Patent Application Publication
(10) Pub. No.: US 2011/0119038 A1
(43) Pub. Date: May 19, 2011

(54) PARALLEL COMPUTING SYSTEM THAT PERFORMS SPHERICAL HARMONIC TRANSFORMS, AND CONTROL METHOD AND CONTROL PROGRAM FOR PARALLEL COMPUTING SYSTEM

(75) Inventors: Yusuke OISHI, Kawasaki (JP); Ataru Sakuraba, Bunkyo (JP)

(73) Assignee: FUJITSU LIMITED, Kawasaki (JP)

(21) Appl. No.: 12/779,275

(22) Filed: May 13, 2010

(30) Foreign Application Priority Data
Nov. 16, 2009 (JP) 2009-261359

(51) Int. Cl. G06F 17/14; G06F 17/11

(52) U.S. Cl. 703/2; 708/403

(57) ABSTRACT

A parallel computing system that performs simulation of a sphere by using a spherical harmonic function, and comprises a plurality of computing nodes interconnected with each other via a communication path, wherein each of the computing nodes includes: a storage unit that stores spectral data obtained by dividing spectral space data into a plurality of data elements on the basis of longitudinal wavenumber; a computation unit that performs inverse Legendre transformation for a computation region divided in a latitudinal direction on the sphere and thereby transforms each of the spectral data elements to Fourier coefficient data; and a communication unit that transmits the Fourier coefficient data, obtained through the transformation performed by the computation unit, to another computing node via the communication path after the inverse Legendre transformation for the next computation region divided in the latitudinal direction on the sphere has been started by the computation unit.

### CROSS-REFERENCE TO RELATED APPLICATIONS

This application is based upon and claims the benefit of priority of the prior Japanese Patent Application No. 2009-261359, filed on Nov. 16, 2009, the entire contents of which are incorporated herein by reference.

### FIELD

The embodiments discussed herein are related to a parallel computing system that performs spherical harmonic transforms, and a control method and control program for such a parallel computing system.

### BACKGROUND

In the field of scientific computations, such as weather forecasts and climate predictions, large-scale computer simulations are performed. For such large-scale computer simulations, use is made of a parallel computing system that comprises a plurality of information processing apparatuses interconnected via a network.

For such as weather forecasting, a method is employed that simulates a spherical model of the three-dimensional surface of the Earth by using a parallel computing system. One of the techniques used for the simulation of a spherical model when performing global weather forecasts, etc., is the spherical spectral transform method.

The spherical spectral transform method is a numerical analysis method that uses a spherical harmonic function to solve a function defined on a sphere. Since the spherical spectral transform method uses an expansion function, the method is free from errors associated with a finite difference method that performs finite difference approximations of partial derivatives. Accordingly, the spherical spectral transform method can provide solutions of high accuracy compared with the finite difference method.
[Patent Document] Japanese Laid-open Patent Publication No. 2004-348493
[Non-patent Document 1] Keiichi Ishioka, “Introduction to Spectral Methods,” University of Tokyo Press, p. 117-130, 2004.11.22[Non-patent Document 2] Juang, H.-M, 2004: A Reduced Spectral Transform for the NCEP Seasonal Forecast Global Spectral Atmospheric Model. Mon. Wea. Rev., 132, 1019-1035

### SUMMARY

According to an aspect of the embodiment, a parallel computing system that performs simulation of a sphere by using a spherical harmonic function, and comprises a plurality of computing nodes interconnected with each other via a communication path, wherein each of the computing nodes includes a storage unit that stores spectral data obtained by dividing spectral space data into a plurality of data elements on the basis of longitudinal wavenumber; a computation unit that performs inverse Legendre transformation for a computation region divided in a latitudinal direction on the sphere and thereby transforms each of the spectral data elements to Fourier coefficient data; and a communication unit that transmits the Fourier coefficient data, obtained through the transformation performed by the computation unit, to another computing node via the communication path after the inverse Legendre transformation for the next computation region divided in the latitudinal direction on the sphere has been started by the computation unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of the hardware configuration of an information processing apparatus that performs numerical analysis;

FIG. 2 is a diagram illustrating one example of the configuration of a processor core;

FIG. 3A is a diagram illustrating one example of a parallel computing system;

FIG. 3B is a diagram illustrating one example of a functional configuration implemented by a computation apparatus by executing software;

FIG. 4 is a diagram schematically illustrating spherical harmonic transforms;

FIG. 5 is a diagram illustrating one example of how the spherical harmonic transforms are performed at a plurality of nodes;

FIG. 6A is a time chart illustrating one example of the computation performed at a given node when inverse Legendre transformation is performed using four nodes;

FIG. 6B is a time chart illustrating one example of the computation performed at a given node when inverse Legendre transformation is performed using four nodes;

FIG. 6C is a time chart illustrating one example of the computation performed at a given node when inverse Legendre transformation is performed using four nodes;

FIG. 7 is a time chart illustrating one example of how computation processes are executed in parallel at four nodes when the inverse Legendre transformation is performed using the four nodes;

FIG. 8 is a time chart illustrating one example of how communication processes are executed in parallel at the four nodes when the inverse Legendre transformation is performed using the four nodes;

FIG. 9A is a time chart illustrating one example of the computation performed at a given node when Legendre transformation is performed using four nodes;

FIG. 9B is a time chart illustrating one example of the computation performed at a given node when Legendre transformation is performed using four nodes;

FIG. 10 is a time chart illustrating one example of how computation processes are executed in parallel at four nodes when the Legendre transformation is performed using the four nodes;

FIG. 11 is a diagram illustrating one example of a numerical analysis process flow that includes the Legendre transformation;

FIG. 12 is a diagram illustrating one example of a numerical analysis process flow that includes the inverse Legendre transformation;

FIG. 13 is a diagram illustrating one example of a process flow for the inverse Legendre transformation illustrated in FIG. 6B; and

FIG. 14 is a diagram illustrating one example of a process flow for the inverse Legendre transformation illustrated in FIG. 6C.

### DESCRIPTION OF EMBODIMENTS

The numerical computation of a spherical harmonic transform includes the numerical computation of an associated Legendre transformation and that of a Fourier transform. The problem here is the large amount of computation required for the Legendre transformation in the numerical computation of the spherical harmonic transform. For example, when the number of degrees of freedom per dimension is denoted by N, then using a Landau symbol O, the amount of computation required for the Legendre transformation, on a horizontal plane, is given by O(N³). Because of this large amount of computation required for the Legendre transformation, the numerical computation of a spherical harmonic function has had the problem that, compared with a local computation method such as the finite difference method (the amount of computation is (O(N²)), the amount of computation exponentially increases as the resolution is increased by increasing the number of grid points on the sphere. Further, the spherical spectral transform method requires transpose communication whose amount of communication associated with spectral transformation is large; in parallel computation, this also greatly affects the computation time.

The parallel computing system disclosed herein, which performs simulation of a sphere by using a spherical harmonic function, is constructed by interconnecting via a communication path a plurality of computing nodes each comprising: a storage unit which stores spectral data obtained by dividing spectral space data into a plurality of data elements on the basis of longitudinal wavenumber; a computation unit which performs inverse Legendre transformation for a computation region divided in a latitudinal direction on the sphere and thereby transforms each of the spectral data elements to Fourier coefficient data; and a communication unit which transmits the Fourier coefficient data, obtained through the transformation performed by the computation unit, to another computing node via the communication path after the inverse Legendre transformation for the next computation region divided in the latitudinal direction on the sphere has been started by the computation unit.

The parallel computing system disclosed herein can reduce the computation time.

One embodiment of a numerical analysis method and a parallel computing system that performs numerical analysis will be described below with reference to the drawings.

<Description of Hardware and Software Configuration>

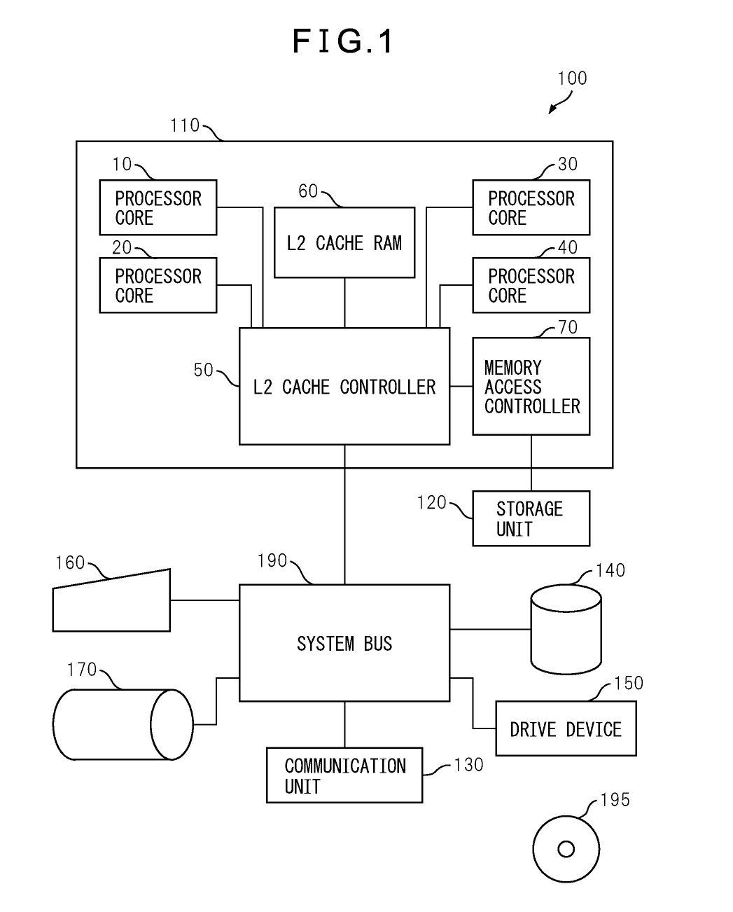

FIG. 1 is a diagram illustrating one example of the hardware configuration of an information processing apparatus as a computing node that performs numerical analysis. The information processing apparatus 100 illustrated in FIG. 1 includes a computation unit 110, a storage unit 120, a communication unit 130, an external storage device 140, a drive device 150, an input unit 160, an output unit 170, and a system bus 190.

The computation unit 110 includes processor cores 10 to 40 which perform computational operations, an L2 (Level 2) cache controller 50 which controls an L2 cache proper, an L2 cache RAM (Random Access Memory) 60 as the L2 cache proper, and a memory access controller 70. The computation unit 110 is connected to the communication unit 130, external storage device 140, drive device 150, input unit 160, and output unit 170 via the system bus 190. The L2 cache controller 50 and the L2 cache RAM 60 together are called the L2 cache.

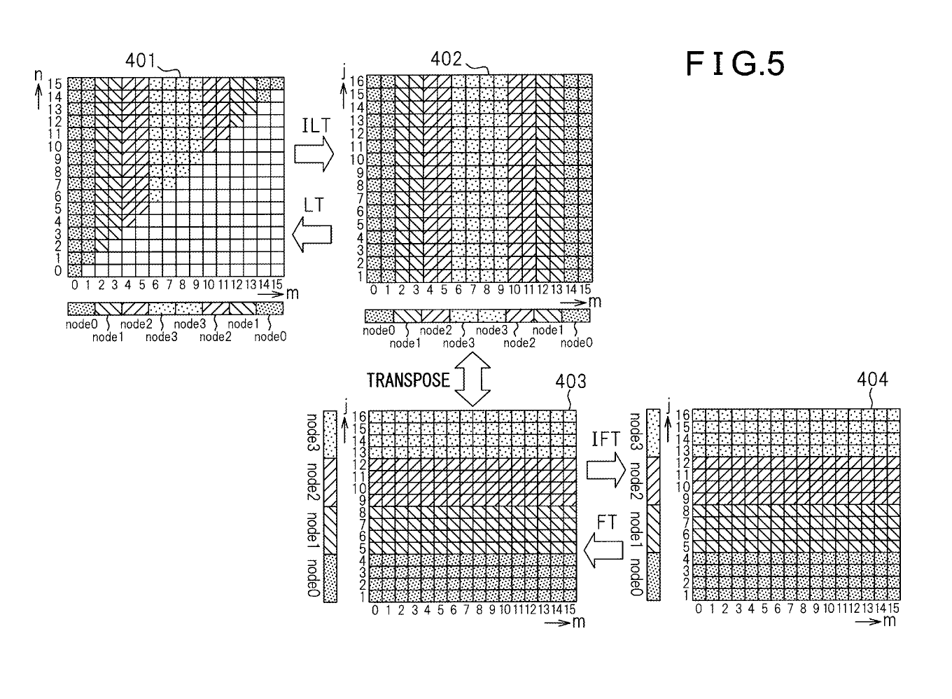

The computation unit 110 receives data from the storage unit 120 or the input unit 160 and performs computational operations on the received data by executing a program 900 stored in the storage unit 120. The computation unit 110 supplies the computed data to the storage unit 120 or the output unit 170. The computation unit 110 is, for example, a CPU (Central Processing Unit). By executing the program 900, the computation unit 110 implements the numerical computation functions of spherical harmonics which will be described later with reference to FIGS. 5 to 14.

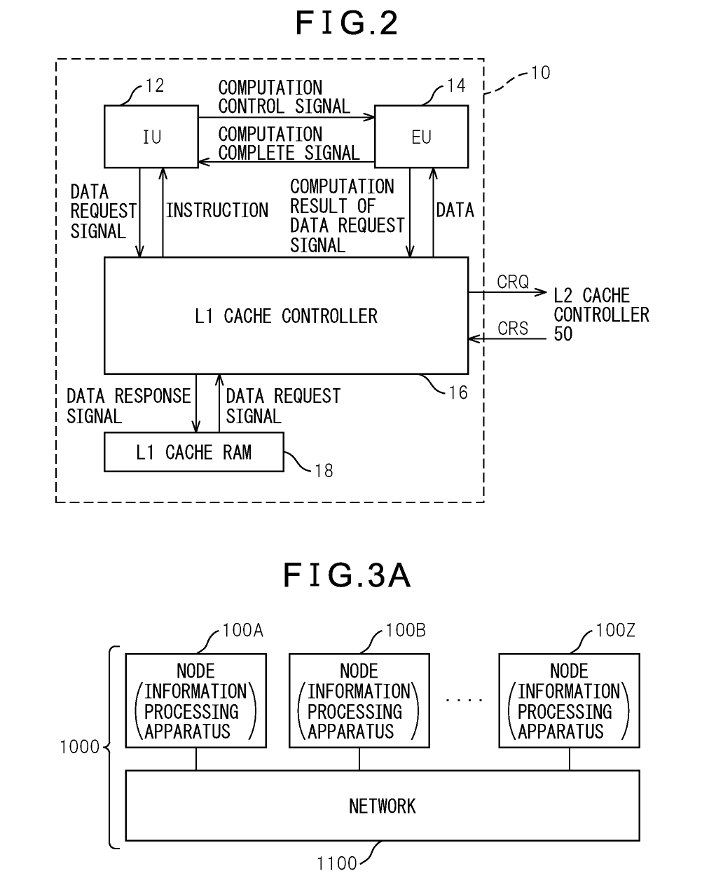

FIG. 2 is a diagram illustrating one example of the configuration of the processor core. The processor core 10 includes an instruction unit (IU) 12, an execution unit (EU) 14, an L1 cache controller 16, and an L1 cache RAM 18. While FIG. 2 specifically illustrates the processor core 10, it will be recognized that the other processor cores 20 to 40 illustrated in FIG. 1 have the same functions as those described here for the processor core 10. In FIG. 1, the number of processor cores is 4, but it need not necessarily be limited to 4, and the information processing apparatus 100 may include more than four processor cores.

The instruction unit 12 decodes an instruction read out of the L1 (Level 1) cache RAM 18. Then, register addresses for specifying a source register that stores an operand to be used for the execution of the instruction and a destination register that is to store the result of the instruction execution are supplied in the form of a “computation control signal” to the execution unit 14. The instruction decoded here is, for example, a load instruction, a store instruction, etc., to the L1 cache RAM 18. The instruction unit 12 reads the instruction from the L1 cache RAM 18 by supplying a data request signal to the L1 cache controller 16.

The execution unit 14 retrieves data from its internal register specified by the register address, and performs computation in accordance with the decoded instruction. The execution unit 14, in accordance with the decoded instruction, supplies the decoded result of the load instruction or store instruction as a “data request signal” to the L1 cache controller 16. The L1 cache controller 16 supplies the data to the execution unit 14 in response to the load instruction. When the execution of the instruction is completed, the execution unit 14 supplies a computation complete signal to the instruction unit 12 and receives the next computation control signal.

The L1 cache controller 16 in the processor core 10 supplies a cache data request signal CRQ to the L2 cache controller 50. Then, the processor core 10 receives a cache data response signal CRS as a completion notification and data or an instruction from the L2 cache controller 50.

The L1 cache controller 16 can operate independently of both the instruction unit 12 and the execution unit 14. Accordingly, while the instruction unit 12 and the execution unit 14 are performing prescribed processing, the L1 cache controller 16 can carry out data or instruction transfers to and from other processor cores independently of the operation of the instruction unit 12 and the execution unit 14.

The L2 cache controller 50 illustrated in FIG. 1 makes a data read (load) request or write (store) request to the L1 cache RAM and the storage unit 120, or loads or stores data to the L2 cache RAM 60. The L2 cache controller 50 loads or stores data, for example, in accordance with the MESI (Modified Exclusive Shared Invalid) protocol, so as to maintain coherency between the data stored in the L1 cache or the storage unit 120 and the data held in the L2 cache.

The L2 cache RAM 60 holds a portion of the data stored in the storage unit 120. Any data held in the L1 cache is also held in the L2 cache RAM 60.

The memory access controller 70 is a circuit that controls such operations as data loading from the storage unit 120, data storing to the storage unit 120, and refreshing of the memory unit 120. The memory access controller 70 loads or stores data to the storage unit 120 in accordance with the load instruction or store instruction received from the L2 cache controller 50.

The system bus 190 connects the computation unit 110 to other connected devices. The system bus 190 is, for example, a circuit that operates in conformance with a bus standard such as AGP (Accelerated Graphics Port) or PCI Express (Peripheral Component Interconnect Express).

The storage unit 120 is, for example, a DRAM (Dynamic Random Access Memory). The external storage device 140 is, for example, a disk array constructed from magnetic disks or an SSD (Solid State Drive) that uses a flash memory. The external storage device 140 can store programs and data to be loaded into the storage unit 120.

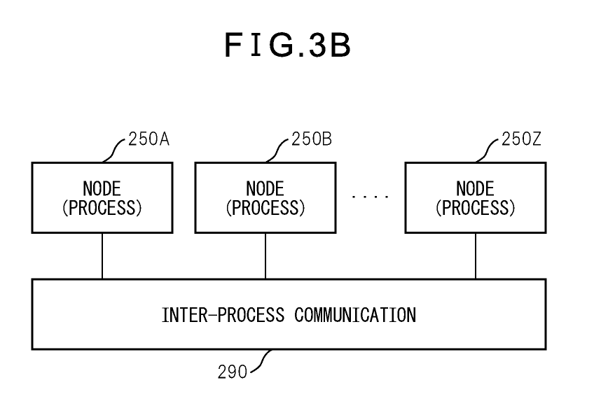

The communication unit 130 is a communication device such as a NIC (Network Interface Controller) that is connected to a network 1100 to be described later as a communication path with reference to FIG. 3A and that transmits and receives data over the network. The communication unit 130 can perform data transfers without involving the processor cores 10 to 40. Accordingly, the communication unit 130 can perform communication operations completely independently of the computational operations of the processor cores. To achieve such data transfers, the communication unit 130 may use, for example, a data transfer scheme called DMA (Direct Memory Access).

The drive device 150 is, for example, a device for reading and writing data on a recording medium 195 such as a floppy (registered trademark) disk, CD-ROM, DVD, or the like. The drive device 150 includes a motor for rotating the recording medium 195 and a head for reading and writing data on the recording medium 195. The recording medium 195 can store the program 900. The drive device 150 reads the program 900 from the recording medium 195 loaded in the drive device 150. The computation unit 110 stores the program read by the drive device 150 into the storage unit 120 and/or the external storage device 140. The input unit 160 is, for example, a keyboard, mouse, etc., as a pointing input device. The output unit 170 is, for example, a display as a display unit.

The information processing apparatus which performs the numerical computation of a spherical harmonic function is constructed using the computation unit 110 that can execute Legendre transformation or Fourier transform processes in parallel fashion. Each information processing apparatus as a computing node is configured so that data communications can be performed with other computing nodes to communicate the results of computations to each other. One example of such a hardware configuration is a parallel computing system that comprises a plurality of information processing apparatuses.

Further, even with a single computation apparatus, by executing the program 900 the apparatus can be made to behave as an information processing apparatus having a plurality of processor cores to execute a plurality of processes or threads in parallel fashion.

Two implementations for performing the numerical computation of a spherical harmonic function, (1) a parallel computing system that comprises a plurality of information processing apparatuses, and (2) a computation apparatus configured to execute a plurality of processes or threads in parallel fashion, will be described below with reference to FIGS. 3A and 3B.

FIG. 3A is a diagram illustrating one example of the parallel computing system. The parallel computing system refers to a system that is constructed by interconnecting a plurality of information processing apparatuses via a network. The parallel computing system 1000 illustrated in FIG. 3A includes a plurality of nodes 100A to 100Z which are interconnected via a network 1100. The nodes 100A to 100Z here may each have the same hardware configuration as that of the information processing apparatus 100 illustrated in FIG. 1. The network 1100 is, for example, a transmission medium conforming to the Ethernet (registered trademark) standard.

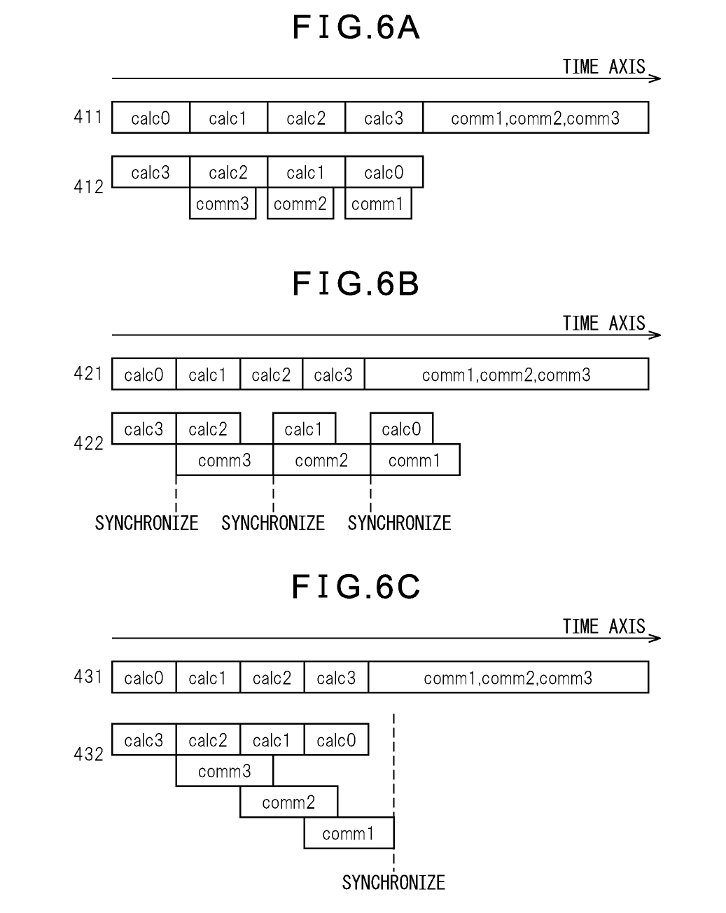

For communications between the nodes illustrated in FIG. 3A, MPI (Message Passing Interface) may be used via the communication unit 130. The MPI is the standard specification for message communication that is used when transferring data between nodes each having its own memory. The MPI defines, for example, a message for synchronizing the start or end of a process performed at each node to the start or end of a process performed at any other node. The message communication based on the MPI specification will be described later with reference to FIGS. 6A to 10.

FIG. 3B is a diagram illustrating one example of a functional configuration implemented by a computation apparatus by executing software. The functional configuration illustrated in FIG. 3B is one that is implemented by each node illustrated in FIG. 3A. The functional configuration illustrated in FIG. 3B includes a plurality of nodes 250A to 250Z. This functional configuration represents data processing known as processes or threads implemented by the computation apparatus. With each node of FIG. 3A executing the program 900, the node implements the functional configuration having the plurality of nodes 250A to 250Z as processes.

Communications between the nodes illustrated in FIG. 3B may be performed using inter-process communication 290. The inter-process communication 290 provides a mechanism for exchanging information between a plurality of processes. The inter-process communication 290 between the nodes of FIG. 3B is implemented on the network illustrated in FIG. 3A. Usually, each process has its own unique virtual address space and operates so as not to interfere with each other. If it is desired to perform collaborative processing between different processes, the inter-process communication enables the processes to transfer and share information across the different address spaces. To implement the inter-process communication, synchronization mechanisms such as message queue, socket, pipe, and semaphore, and techniques such as memory sharing and RPC (Remote Procedure Call) can be applied.

The “node” hereinafter described functions as a processing unit having a computing unit for performing the computation of the spherical harmonic transform to be described later, a storage unit for storing the result of the computation, and a communication unit for transmitting the result of the computation to another “node.” Unless specifically stated otherwise, the term “node” refers to either the plurality of information processing apparatuses illustrated in FIG. 3A or the plurality of processes illustrated in FIG. 3B. Accordingly, the computation of the spherical harmonic transform to be described later is performed by either the information processing apparatus or the computation apparatus.

The communication function for performing transpose communication for the computation result of the spherical harmonic transform is implemented by the communication unit 130.

<Spherical Harmonic Transform>

The spectral transform method is a method for the numerical solution of simulation. The spectrum transform method finds solutions by expanding variables in orthogonal functions, but for the analysis of atmospheric phenomena on the Earth, the spectral transform method finds solutions by expanding variables in spherical harmonic functions.

For example, a weather forecast model solves a set of equations, such as a motion equation, a continuity equation, an energy equation, a state equation, etc. The spectral transform method applies a spherical harmonic transform (referred to as the “forward spherical harmonic transform” or simply as the “forward transform”) to each variable, such as pressure, temperature, wind velocity, etc., in the set of equations. It also performs computation such as the spatial differentiation of variables in spectral space. The forward spherical harmonic transform here refers to the transformation from real space to spectral space.

After computation in spectral space, an inverse spherical harmonic transform is performed, and computations, etc. are performed in real space, including the computation of nonlinear terms such as an advection term in the motion equation and parameterization for incorporating into the model the effects of phenomena lower than the resolution of the model. The inverse spherical harmonic transform here refers to the transformation from spectral space to real space.

The above computational process is repeated every time step until the simulation is completed. That is, the forward and inverse transforms are performed every time step, moving back and forth between the real space and the spectral space.

In this way, the forward and inverse spherical harmonic transforms are used in order to carry out the simulation of the weather forecast model. The forward and inverse spherical harmonic transforms will be described below.

The real space is defined by a grid-point function g(λₖ, μᵢ) of the grid-point location k=0, 1, . . . . K in the longitudinal direction on the sphere and the grid-point location j=0, 1, . . . , J in the latitudinal direction on the sphere. The function g(λₖ, μᵢ) defined on the sphere is expanded using a spherical harmonic function Yₙ^{m} (λₖ, μᵢ) as indicated by the following equation (1).

$$g ( {λ}_{k} , {μ}_{j} ) = {\sum }_{m = - M}^{M} {\sum }_{n = \vert m \vert}^{N ( m )} {s}_{n}^{m} {Y}_{n}^{m} ( {λ}_{k} , {μ}_{j} ) \qquad ( 1 )$$

Here, λₖ represents the grid-point location in the longitudinal direction, μᵢ the Gaussian latitudinal point where the Legendre polynomial is zero, and (λₖ, μᵢ) the grid-point location defined on a spherical coordinate system. The function g(λₖ, μᵢ) has such states as temperature, pressure, and wind velocity. Further, n represents the wavenumber corresponding to the grid-point location j in the latitudinal direction, and m the grid-point location k in the longitudinal direction. The expansion coefficient Sₙ^{m} of the spherical harmonic function Yₙ^{m} (λₖ, μᵢ) indicates the state in the spectral space. Hereinafter, n is referenced to as “latitudinal wavenumber” or “degree,” and m is referenced to as “longitudinal wavenumber” or “order.”

The spherical harmonic function Yₙ^{m} (μₖ, μᵢ) is defined as indicated by the following equation (2) by using a Legendre function Pₙ^{m} and a complex exponential function e^{imλk}.

Yₙ^{m}(λₖ,μⱼ)=Pₙ^{m}(μⱼ)e^{imλ}k (2)

As indicated by the equation (2), the spherical harmonic function Yₙ^{m} (λₖ, μᵢ) is defined by the product of the Legendre function Pₙ^{m} and the complex exponential function e^{imλk}. Accordingly, in the inverse transformation for obtaining the function g(λₖ, μᵢ) from the state Sₙ^{m}, the following equations (3A) and (3B) are derived from the above equations (1) and (2). When g is a real number, Sₙ^{m} need only be obtained for the range of m≧0, which means that actually the equation (3D) is solved.

As indicated by the equation (3B), the inverse Legendre transformation can be performed by dividing the process on the basis of the wavenumber m. Accordingly, when the plurality of nodes perform the inverse associated Legendre transformation, each node performs the inverse associated Legendre transformation for a computation region divided based on the wavenumber m on the sphere.

In the inverse transformation for obtaining the real space variables g(λₖ, μᵢ) from the expansion coefficient Sₙ^{m} of the spherical harmonic function, the following equations (4) and (5) are used.

$$\begin{matrix} g ( {λ}_{k} , {μ}_{j} ) = {\sum }_{m = - M}^{M} {G}^{m} ( {μ}_{j} ) {e}^{i m {λ}_{k}} \\ ( 0 \leq k \leq K , 1 \leq j \leq J ) & ( 3 A ) \\ {G}^{m} ( {μ}_{j} ) = {\sum }_{n = \vert m \vert}^{M} {s}_{n}^{m} {P}_{n}^{m} ( {μ}_{j} ) \\ ( - M \leq m \leq M , 1 \leq j \leq J ) & ( 3 B ) \\ g ( {λ}_{k} , {μ}_{j} ) = {G}^{0} ( {μ}_{j} ) + 2 {\sum }_{m = 1}^{M} [ Re ( {G}^{m} ( {μ}_{j} ) ) cos m {λ}_{k} - Im ( {G}^{m} ( {μ}_{j} ) ) sin m {λ}_{K} ] \\ ( 0 \leq k \leq K , 1 \leq j \leq J ) & ( 3 C ) \\ {G}^{m} ( {μ}_{j} ) = {\sum }_{n = m}^{M} {s}_{n}^{m} {P}_{n}^{m} ( {μ}_{j} ) \\ ( 0 \leq m \leq M , 1 \leq j \leq J ) & ( 3 D )\end{matrix}$$

When g is a real number, Sₙ^{m} need only be obtained for the range of m≧0, which means that actually the following inverse Fourier transform (4) and inverse Legendre transform (5) are solved. Here, G^{m} and Sₙ^{m} are complex numbers.

$$\begin{matrix}{G}^{m} ( {μ}_{j} ) = \frac{1}{K} {\sum }_{k = 0}^{K - 1} g ( {λ}_{k} , {μ}_{j} ) {e}^{- i m {λ}_{k}} \\ ( 0 \leq m \leq M , 1 \leq j \leq J ) & ( 4 ) \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( 0 \leq m \leq M , m \leq n \leq M ) & ( 5 )\end{matrix}$$

In the equation (5), ωⱼ is a weight for numerical integration, and is called a “Gaussian weight.” As indicated by the equations (4) and (5), in the forward transformation from the real space to the spectral space, the Fourier transform indicated by the equation (4) is performed, and after that, the Legendre transform indicated by the equation (5) is performed, to obtain solutions in the spectral space.

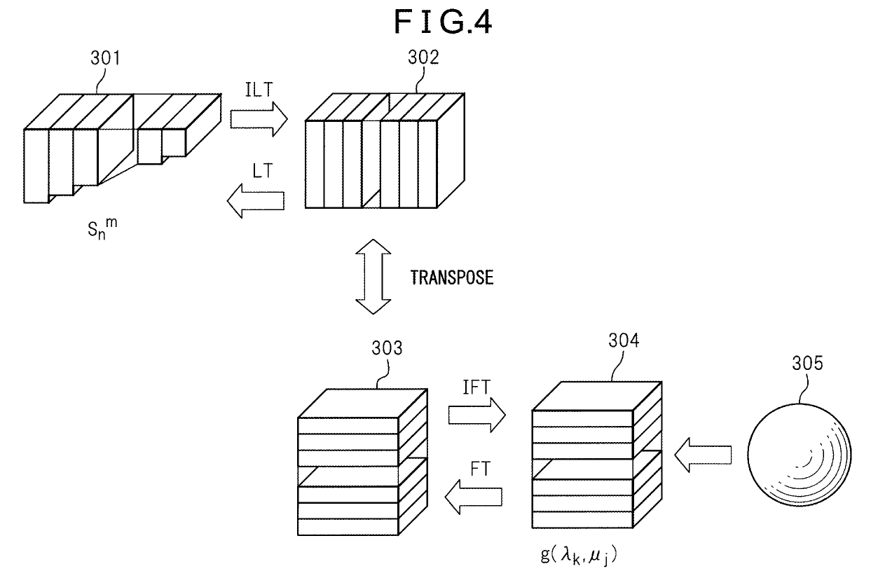

FIG. 4 is a schematic diagram for explaining the spherical harmonic transforms. FIG. 4 illustrates the relationship relative to real data 304 based on a spherical body 305. In FIG. 4, spectral data 301 is the data in the spectral space defined by the latitudinal wavenumber n and the longitudinal wavenumber m, i.e., the spectral data obtained by dividing the data in the spectral space into a plurality of data elements based on the longitudinal wavenumber. The space on the spherical body 305 is defined as the real data 304 in the real space by using the function g(λₖ, μᵢ) of the grid-point location λₖ in the longitudinal direction on the sphere and grid-point location μᵢ in the latitudinal direction on the sphere.

The inverse transformation of the spherical harmonic function from the spectral data 301 to the real data 304 is performed in accordance with the following steps.

Step 1a: Inverse Legendre Transformation (ILT)

G^{m}(μⱼ) is obtained from Sₙ^{m} by the inverse Legendre transformation at each node. In this step, the spectral data 301 is transformed to first Fourier coefficients 302.

Step 2a: Longitude-to-Latitude Data Transpose Communication

Transpose communication is performed between the plurality of nodes. Each node performs the inverse Legendre transformation for the computation region divided based on the longitudinal wavenumber m. On the other hand, G^{m}(μⱼ) computed at each node is used as a Fourier coefficient in the Fourier transform. For this purpose, any given node transmits the computed G^{m}(μⱼ) to the other nodes. The communication process in which the solutions obtained at the respective nodes after the numerical analysis are transposed in this manner is referred to as “transpose communication.”

In this step, G^{m}(μⱼ) is transmitted from each node assigned in the longitudinal direction as indicated by the first Fourier coefficients 302 to the other nodes assigned in the latitudinal direction as indicated by the second Fourier coefficients 303. In this case, by performing data transfer using, for example, DMA (Direct Memory Access), the load of the computation unit during the data transfer can be reduced, enabling the communication by the communication unit 130 and the calculation by the computation unit 110 to proceed concurrently.

Step 3a: Inverse Fourier Transform (IFT)

g(λₖ, μᵢ) is obtained from G^{m}(μⱼ) by the inverse Fourier transform. In this step, the second Fourier coefficients 303 obtained by the transposition are transformed to the real data 304.

As can be seen, the Fourier coefficients mean the plurality of data elements obtained by dividing the data in the spectral space on the basis of the longitudinal wavenumber or in the longitudinal direction.

The forward transformation of the spherical harmonic function from the real data 304 to the spectral data 301 is performed at each of the plurality of nodes in FIGS. 3A and 3B in accordance with the following steps.

Step 1b: Fourier Transform (FT)

G^{m}(μⱼ) is obtained from g(λₖ, μᵢ) by the Fourier transform at each node. In this step, the real data 304 is transformed to the second Fourier coefficients 303.

Step 2b: Latitude-to-Longitude Data Transpose Communication

Transpose communication is performed between the plurality of nodes. In this step, G^{m}(μⱼ) is transmitted from each node assigned in the latitudinal direction as indicated by the second Fourier coefficients 303 to the other nodes assigned in the longitudinal direction as indicated by the first Fourier coefficients 302.

Step 3b: Legendre Transformation (LT)

Sₙ^{m} is obtained from G^{m}(μⱼ) by the Legendre transformation. In this step, the first Fourier coefficients 302 are transformed to the spectral data 301.

<Parallelization of Spherical Harmonic Transform>

The Legendre transformation and the Fourier transform described above can each be performed in parallel at many nodes by dividing the computation region.

[Parallelization of Inverse Transform] As one example of the parallelization of the spherical harmonic transform, a description will be given of a one-dimensional parallel implementation method for the case where the truncation wavenumber for the latitudinal wavenumber n in the equation (1) is chosen to be N(m)=M.

FIG. 5 is a schematic diagram for explaining one example of how data is divided for the spherical harmonic transform at the plurality of nodes according to the present embodiment. In FIG. 5, the abscissa represents the grid-point location in the longitudinal direction and the ordinate the grid-point location in the latitudinal direction. In the example illustrated in FIG. 5, the longitudinal resolution is M=15, and the latitudinal resolution is J=16. The number of nodes that perform the computation of the spherical harmonic function is 4.

The associated Legendre function has values only for n≧m. In the above step 1a, the Legendre transformation for the computation region symmetrical about the midpoint between (M−1)/2 and (M−1)/2+1 is assigned to each node in order to equalize the processing among the nodes. That is, in the example of the spectral data 401 illustrated in FIG. 5, since M=15, the Legendre transformation for the computation region symmetrical about the midpoint between m=(15−1)/2=7 and m=(15−1)/2+1=8 is assigned to each node. By thus distributing the amount of computation evenly among the nodes, the plurality of nodes can execute the processes in parallel fashion.

Equations indicating the Legendre transformation processes assigned to the four nodes by dividing the computation region based on the longitudinal wavenumber m will be given below.

$$\begin{matrix}Node 0 \text{:} & \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ \{ 0 , 1 , 14 , 15 \} , m \leq n \leq M ) & ( 5 \text{-} 1 ) \\ Node 1 : & \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ \{ 2 , 3 , 12 , 13 \} , m \leq n \leq M ) & ( 5 \text{-} 2 ) \\ Node 2 \text{:} & \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ \{ 4 , 5 , 10 , 11 \} , m \leq n \leq M ) & ( 5 \text{-} 3 ) \\ Node 3 \text{:} & \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ \{ 6 , 7 , 8 , 9 \} , m \leq n \leq M ) & ( 5 \text{-} 4 )\end{matrix}$$

The spectral data 401 in FIG. 5 indicates that the Legendre transformation for the computation regions where the longitudinal wavenumber m is 0, 1, 14, and 15, respectively, is assigned to the node 0, as can be seen from the equation (3D-1).

The spectral data 401 in FIG. 5 indicates that the Legendre transformation for the computation regions where the longitudinal wavenumber m is 2, 3, 12, and 13, respectively, is assigned to the node 1, as can be seen from the equation (3D-2).

The spectral data 401 in FIG. 5 indicates that the Legendre transformation for the computation regions is assigned to the node 2 where the longitudinal wavenumber m is 4, 5, 10, and 11, respectively, as can be seen from the equation (3D-3).

The spectral data 401 in FIG. 5 indicates that the Legendre transformation for the computation regions where the longitudinal wavenumber m is 6, 7, 8, and 9, respectively, is assigned to the node 3, as can be seen from the equation (3D-4).

The above equations (3D-1) to (3D-4) indicate the Legendre transformation processes assigned to the four nodes by dividing the computation region on the basis of the longitudinal wavenumber m. On the other hand, an equation generalized for the computation region of a node i when the process is parallelized among Np nodes from node 0 to node Np−1 can be given by the following equation (6).

$${G}^{m} ( {μ}_{j} ) = {\sum }_{n = m}^{M} {s}_{n}^{m} {P}_{n}^{m} ( {μ}_{j} ) \\ ( m ∈ {C}_{i} , 1 \leq j \leq J ) \qquad ( 6 )$$

Here, Ci represents a subset indicating the computation regions assigned to the node i on the basis of the longitudinal wavenumber m, and satisfies the following relations.

C₀∪C₁∪···Cᵢ₋₁∪Cᵢ∪Cᵢ₊₁···∪C_{Np-1}={m|0≦m≦M}

C₀∩C₁∩···Cᵢ₋₁∩Cᵢ∩Cᵢ₊₁···∩C_{Np-1}=φ

The above relationships include not only the method that assigns the computation regions so as to be symmetrical about the midpoint between (M−1)/2 and (M−1)/2+1 in the spectral data 401, but also various other data division method. For example, in the reduced spectral transform method (see earlier given non-patent document 2) frequently used for climate models, there is indicated a method that limits the computation region by considering the speedup of the processing. When equalizing the processing among the nodes, if the computation region is assigned to each node so as to be symmetrical about the midpoint between (M−1)/2 and (M−1)/2+1 and so as to be cyclic in the lateral direction, the processing can be equalized easily among the nodes.

The first Fourier coefficients 402 in FIG. 5 indicate the Fourier space obtained by the inverse Legendre transformation. The Fourier coefficients obtained on a wavenumber-by-wavenumber basis by the inverse Legendre transformation are stored in the L2 cache RAM 60 or storage unit 120 illustrated in FIG. 1 or in the L1 cache RAM 18 illustrated in FIG. 2. The latitudinal wavenumber n is transformed to a latitudinal location value in the real space. Transpose communication is performed in step 2a, and any given node transmits the result of the inverse Legendre transformation, G^{m}(μⱼ), to all the other nodes.

The second Fourier coefficients 403 in FIG. 5 indicate the Fourier space obtained by the transpose communication. The Fourier coefficients obtained on a wavenumber-by-wavenumber basis by the transpose communication are stored in the L2 cache RAM 60 or storage unit 120 illustrated in FIG. 1 or in the L1 cache RAM 18 illustrated in FIG. 2. In the example illustrated in FIG. 5, since 1≦j≦16, and since the Fourier coefficients for all the longitudinal wavenumbers are used for computation in the Fourier transform, inverse Fourier transform processes for the following computation regions are assigned to the respective nodes 0 to 3.

Node 0: 0≦m≦M, 1≦j≦4

Node 1: 0≦m≦M, 5≦j≦8

Node 2: 0≦m≦M, 9≦j≦12

Node 3: 0≦m≦M, 13≦j≦16

By performing the thus assigned inverse Fourier transform, each node computes g(λₖ, μⱼ) for the following real space region. The thus computed g is stored in the L2 cache RAM 60 or storage unit 120 illustrated in FIG. 1 or in the L1 cache RAM 18 illustrated in FIG. 2. In the forward transform described hereinafter also, the computation results of the Fourier transform or Legendre transform performed at each node or obtained by the transpose communication are stored in the L2 cache RAM 60 or storage unit 120 illustrated in FIG. 1 or in the L1 cache RAM 18 illustrated in FIG. 2.

The real space data 404 in FIG. 5 indicates the real space obtained by the inverse Fourier transform.

When parallelizing the Fourier transform among the Np nodes from node 0 to node Np−1, the computation region assigned to any given node k is defined as indicated by the following equation (7).

$$0 \leq m \leq M \frac{kJ}{Np} + 1 \leq j \leq \frac{J}{Np} ( k + 1 ) \qquad ( 7 )$$

<Parallelization of Forward Transform>

As earlier described with reference to FIG. 4, the forward transformation of the spherical harmonic function is the reverse of the inverse transformation of the spherical harmonic function. Accordingly, the computation regions assigned to the respective nodes when performing the Fourier transform (FT) from the real space data 404 to the second Fourier coefficients 403 are the same as those assigned to them when performing the inverse Fourier transform described with reference to FIG. 5. For example, as indicated by the real space data 404, the respective nodes are assigned the following computation regions, and each node performs the computation of the equation (1) for the assigned computation region.

Node 0: 0≦k≦K, 1≦j≦4

Node 1: 0≦k≦K, 5≦j≦8

Node 2: 0≦k≦K, 9≦j≦12

Node 3: 0≦k≦K, 13≦j≦16

When parallelizing the Fourier transform among the Np nodes from node 0 to node Np−1, the computation region assigned to any given node k is defined by the above equation (7).

The computation regions assigned to the respective nodes when performing the Legendre transformation (LT) from the first Fourier coefficients 402 to the spectral data 401 are the same as those assigned to them when performing the inverse Legendre transformation. The computation region is thus divided based on the longitudinal wavenumber m, and the inverse Legendre transformation processes for the respective computation regions are assigned to the four nodes. The computation processes assigned to the respective nodes here are as follows.

$$\begin{matrix}Node 0 \text{:} & \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ \{ 0 , 1 , 14 , 15 \} , m \leq n \leq M ) \\ Node 1 \text{:} & ( 5 \text{-} 1 ) \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ \{ 2 , 3 , 12 , 13 \} , m \leq n \leq M ) \\ Node 2 \text{:} & ( 5 \text{-} 2 ) \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ \{ 4 , 5 , 10 , 11 \} , m \leq n \leq M ) \\ Node 3 \text{:} & ( 5 \text{-} 3 ) \\ {s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ \{ 6 , 7 , 8 , 9 \} , m \leq n \leq M ) & ( 5 \text{-} 4 )\end{matrix}$$

The above parallelization of the nodes that perform the inverse Legendre transformation has been done on the four nodes. When parallelizing the inverse Legendre transformation among the Np nodes from node 0 to node Np−1, the computation region of any given node i is defined as indicated by the following equation (8).

$${s}_{n}^{m} = \frac{1}{2} {\sum }_{j = 1}^{J} {ω}_{j} {G}^{m} ( {μ}_{j} ) {P}_{n}^{m} ( {μ}_{j} ) \\ ( m ∈ {C}_{i} , m \leq n \leq M ) \qquad ( 8 )$$

### <Method for Overlapping Processing of Transpose Communication and Numerical Analysis>

### [Inverse Transform]

In one embodiment, the inverse Legendre transformation in step 1a and the transpose communication in step 2a are each divided into a plurality of processes, and the inverse Legendre transformation and the transpose communication are allowed to proceed in overlapping fashion thereby hiding the delays due to the communication. The following describes (a) method of dividing the ILT computation process and the transpose communication process, (b) method of overlapping, and (c) enhancement of the efficiency of overlapping.

(a) Method of Dividing the ILT Computation Process and the Transpose Communication Process

If the inverse Legendre transformation process and the transpose communication process are to be executed in overlapping fashion, the data that the inverse Legendre transformation process uses and the data that the transpose communication process uses must be independent of each other. In the example illustrated below, in order to assign the inverse Legendre transformation processes to the Np nodes from node 0 to node Np−1, the computation at the node i, indicated by the equation (6), is divided into computation processes calc(0) to calc(Np−1), as indicated by the following equation (9).

$$\begin{matrix} & ( 9 ) \\ calc ( 0 ) \\ {G}^{m} ( {μ}_{j} ) = {\sum }_{n = m}^{M} {s}_{n}^{m} {P}_{n}^{m} ( {μ}_{j} ) \\ ( m ∈ {C}_{i} , 1 \leq j \leq \frac{J}{Np} ) & \\ \begin{matrix}( m ∈ {C}_{i} , 1 \leq j \leq \frac{J}{Np} ) \\ calc ( 1 ) \\ {G}^{m} ( {μ}_{j} ) = {\sum }_{n = m}^{M} {s}_{n}^{m} {P}_{n}^{m} ( {μ}_{j} ) \\ ( m ∈ {C}_{i} , \frac{J}{Np} + 1 \leq j \leq \frac{2 J}{Np} ) \\ … \\ calc ( k ) \\ {G}^{m} ( {μ}_{j} ) = {\sum }_{n = m}^{M} {s}_{n}^{m} {P}_{n}^{m} ( {μ}_{j} ) \\ ( m ∈ {C}_{i} , \frac{kJ}{Np} + 1 \leq j \leq \frac{J}{Np} ( k + 1 ) ) \\ …\end{matrix} & \\ \begin{matrix}calc ( {N}_{p} \text{-} 1 ) \\ {G}^{m} ( {μ}_{j} ) = {\sum }_{n = m}^{M} {s}_{n}^{m} {P}_{n}^{m} ( {μ}_{j} ) \\ ( m ∈ {C}_{i} , J - \frac{J}{Np} + 1 \leq j \leq J )\end{matrix} & \end{matrix}$$

By computing all the processes calc(0) to calc(Np−1), the same computation result as that of the equation (6) can be obtained. The computation region for calc(k), in terms of the latitudinal location j, is the same as the computation region of the node k defined by the equation (7) in terms of the latitudinal location j in the Fourier space obtained by the transpose communication.

When attention is paid to calc(k), the computation region in terms of the latitudinal location j coincides with the computation region of the node k defined by the equation (7) in terms of the latitudinal location j in the Fourier space obtained by the transpose communication. That is, when the transmission of the computation result of calc(k) (0≦k≦Np−1) is denoted by comm(k) (0≦k≦Np-1), the destination of comm(k) is the node k.

As indicated by the equation (3D), the inverse Legendre transformation process can be divided based on the wavenumber m. However, if the size of the wavenumber set to be divided is made too small, in step 2a the data transpose communication from one given node to the node k has to be performed a plurality of times, and thus the latency for the start of communication increases, increasing the overall processing time at the node. In view of this, in the present embodiment, the computation region is defined so as to conform to the equation (7) and, as indicated by the equation (3D-1) to (3D-4), for example, the computation is divided into computation processes calc(0) to calc(Np−1). In this way, according to the present embodiment, by making provisions to complete the data transpose communication from one given node to the node k in a single process, the latency for the start of communication can be minimized and the overall processing time reduced.

(b) Method of Overlapping

In one embodiment, as the computation of calc(k) is completed, its computation result, Gₘ (μⱼ) (mεC_i, ij/Np+1≦j≦J(k+1)/Np), is transmitted without waiting for the entire computation process to complete. When the inverse Legendre transformation process is divided in accordance with (a), the transpose communication comm(x) of the computation result of calc(x) and the computation of calc(k) (k<x−1, k>x+1) can be executed independently of each other. This is because the result of a given computation process calc(x) is not affected by calc(k) (k<x−1, k>x+1) and, if the computation result is transmitted to the other nodes by means of the transpose communication, it does not affect the inverse Legendre transformation process at all.

FIGS. 6A to 6C are time charts each illustrating one example of the computation performed at a given node when the inverse Legendre transformation is performed using four nodes. FIG. 6A illustrates the case where the computation time of the Legendre transformation is longer than the communication time required to transmit the result of the Legendre transformation. FIG. 6B illustrates the case where the computation time of the Legendre transformation is shorter than the communication time required to transmit the result of the Legendre transformation.

In the process 411 illustrated in FIG. 6A, all the computation results are transmitted after the node has completed all the computation processes. That is, in the process 411, the communication processes “comm1” to “comm3” are executed after completing all the computation processes “calc0” to “calc3.” On the other hand, in the process 412 illustrated in FIG. 6A, the moment the computation process for one computation region is completed, the result of the completed computation is transmitted. That is, in the process 412, the total processing time of the computation process and communication process becomes shorter than that in the process 411, because the computation process for the next computation region and the communication process for the transmission of the result of the computation for the preceding computation region are allowed to proceed in overlapping fashion. Stated another way, the communication processing time for “comm1” to “comm3” is hidden or masked by the computation processing time for “calc0” to “calc2.”

In the process 421 illustrated in FIG. 6B, all the computation results are transmitted after the node has completed all the computation processes. That is, in the process 421, the communication processes “comm1” to “comm3” are executed after completing all the computation processes “calc0” to “calc3.” On the other hand, in the process 422 illustrated in FIG. 6B, the moment the computation process for one computation region is completed, the result of the completed computation is transmitted. Then, in the process 422, in synchronism with the end timing of one communication process, the node performs processing to start the computation process for the next computation region. Such synchronization can be achieved using an MPI function called MPI_Barrier.

Unlike the process 412 illustrated in FIG. 6A, the processes 421 and 422 illustrated in FIG. 6B concern the case where the communication time is longer than the computation time. On the other hand, in the process 422 illustrated in FIG. 6B, as in the process 412 illustrated in FIG. 6A, the total processing time of the computation process and communication process becomes shorter than that in the process 421, because the computation process for the next computation region and the communication process for the transmission of the result of the computation for the preceding computation region are allowed to proceed in overlapping fashion.

In the process 431 illustrated in FIG. 6C, all the computation results are transmitted after the node has completed all the computation processes. That is, in the process 431, the communication processes “comm1” to “comm3” are executed after completing all the computation processes “calc0” to “calc3.” On the other hand, in the process 432 illustrated in FIG. 6C, the next computation process is executed in parallel with the communication process without confirming whether the computation result has been received at the receiving node. Such synchronization can be achieved using non-blocking communication conforming to the MPI. For example, by transmitting the computation result (for example, comm3) in accordance with the MPI (for example, MPI_Barrier), the transmitting node of the computation result starts the next computation process (for example, calc1) without waiting for the completion of the reception at the receiving node. By achieving synchronization between the receiving node and the transmitting node after the transmission of the final computation result, as in the process 432, the total processing time may become shorter than that in the process 422.

The parallel execution of the computation process and transmission process can be achieved as illustrated in the above processes 412, 422, and 423, because the computation unit and the communication unit are separate units capable of operating independently of each other as illustrated in FIGS. 1 and 2.

By performing the respective processes so that the computation time and the communication time overlap each other as described above, the communication time can be hidden from the total processing time, achieving the parallel processing effect of the parallel computation and thus making possible the effectively utilization of the computing nodes. This serves to reduce the overall processing time.

(c) Enhancement of the Efficiency of Overlapping

According to the algorithm of the present invention, the execution of the computation process divided by the method (a) is not necessarily started from j=1 but, for any node k, the computation is executed in descending order or ascending order of the computation processes calc(0) to calc(Np−1) in such a manner that calc(k) is executed last. That is, in the case of the descending order, for any node x, the computation starts with calc(x−1) and proceeds in the order of calc(x−2), calc(x−3), and so on.

However, in the case of the node 0, the computation starts with calc(Np−1). After computing calc(0), calc(Np−1) is computed. In the case of the ascending order, for any node x, the computation starts with calc(x+1) and proceeds in the order of calc(x+2), calc(x+3), and so on. However, in the case of the node Np−1, the computation starts with calc(0). After computing calc(Np−1), calc(0) is computed.

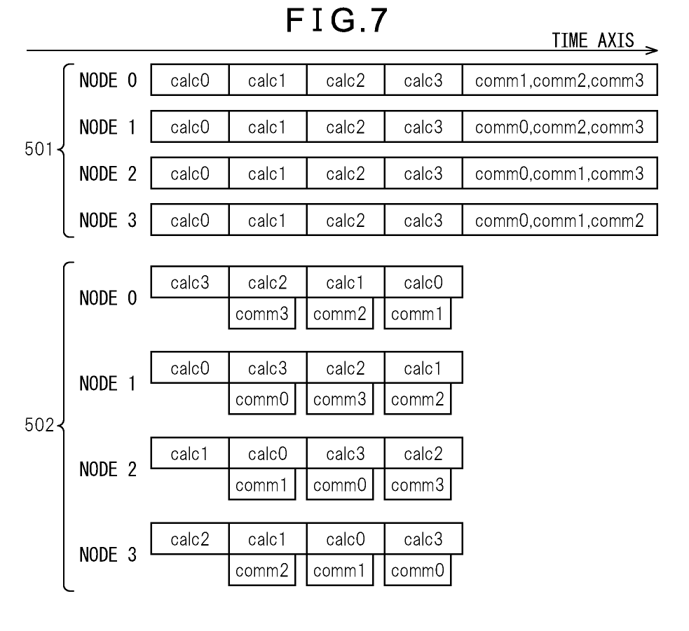

FIG. 7 is a time chart illustrating one example of how the computation processes are executed in parallel at four nodes when the inverse Legendre transformation is performed using the four nodes. In the process 501 illustrated in FIG. 7, all the computation results are transmitted after the four nodes have completed all the computation processes. On the other hand, in the process 502 illustrated in FIG. 7, after the computation regions according to the equations (3D-1) to (3D-4) have been assigned to the respective nodes, each node executes the computation of the associated Legendre function in accordance with the dividing method indicated by the equation (9) and transmits the computation results to the other nodes. As illustrated in FIG. 7, compared with the process 501, the process 502 can reduce the processing time of computation and communication.

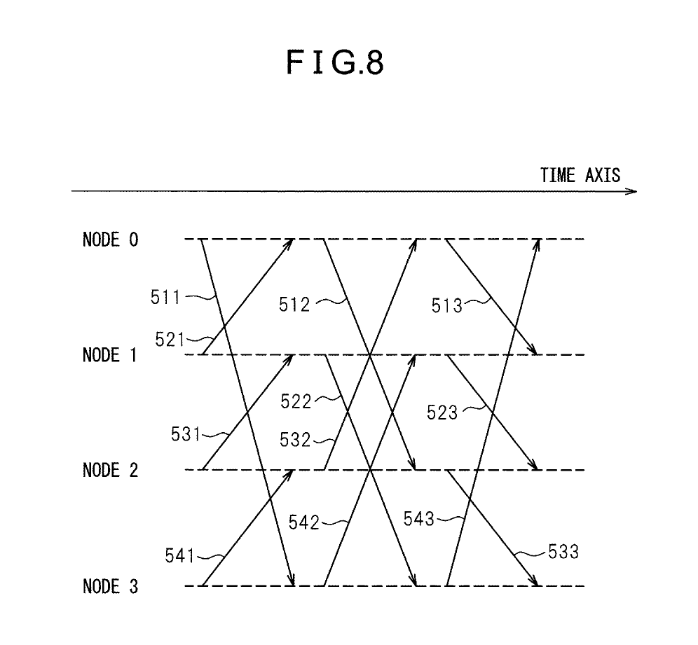

FIG. 8 is a time chart illustrating one example of how the communication processes are executed in parallel at the four nodes for the case where the inverse Legendre transformation is performed by the four nodes and where the computation is executed in descending order of the computation processes calc(0) to calc(Np−1) in such a manner that, for any given node k, calc(k) is executed last. In FIG. 8, the inter-node communication is performed in the direction indicated by each arrow. For example, arrow 511 indicates comm3 performed by the node 0 in the communication from node 0 to node 3. Arrow 512 indicates comm1 performed by the node 0 in the communication from node 0 to node 2. Arrow 513 indicates comm2 performed by the node 0 in the communication from node 0 to node 1.

Further, arrow 521 indicates comm0 performed by the node 1 in the communication from node 1 to node 0. Arrow 522 indicates comm3 performed by the node 1 in the communication from node 1 to node 3. Arrow 523 indicates comm2 performed by the node 1 in the communication from node 1 to node 2.

Further, arrow 531 indicates comm1 performed by the node 2 in the communication from node 2 to node 1. Arrow 532 indicates comm0 performed by the node 2 in the communication from node 2 to node 0. Arrow 533 indicates comm3 performed by the node 2 in the communication from node 2 to node 3.

Further, arrow 541 indicates comm2 performed by the node 3 in the communication from node 3 to node 2. Arrow 542 indicates comm1 performed by the node 3 in the communication from node 3 to node 1. Arrow 543 indicates comm0 performed by the node 3 in the communication from node 3 to node 0.

In the above processing procedure, since calc(k) handles data whose computation result need not be transmitted for the node k, the communication for the last executed computation process is not needed. In this way, all the communication processes are executed in overlapping fashion with the computation of the Legendre transformation that requires a large amount of computation, and this serves to reduce the overall processing time. Further, as illustrated in FIG. 8, in any one communication phase each node either transmits or receives and does not receive two computation results, and in each communication phase, all the nodes perform one transmit or one receive process. In this way, the numerical analysis method disclosed herein can perform the communication effectively by evenly distributing the communication load over the plurality of nodes.

[Forward Transform]

In one embodiment, the computation in step 3b and the communication in step 2b are each divided into a plurality of processes, and the thus divided computation and communication processes are executed in overlapping fashion thereby hiding the delays due to the communication. The following describes (a) method of dividing the computation process and the communication process, (b) method of overlapping, and (c) enhancement of the efficiency of overlapping.

(a) Method of Dividing the Computation Process and the Communication Process

If the computation process and the communication process are to be executed in overlapping fashion, the data that the computation process uses and the data that the communication process uses must be independent of each other. In the example illustrated below, when parallelizing the processes among the Np nodes from node 0 to node Np−1, the computation at the node i, indicated by the equation (8), is divided into NP computation processes calc(0) to calc(Np−1), as illustrated below.

$$\begin{matrix} & ( 10 ) \\ \begin{matrix}{s}_{n 0}^{m} = \frac{1}{2} {\sum }_{j = 1}^{\frac{J}{Np}} {ω}_{j} {G}^{m} ( {μ}_{j} ) {P}_{n}^{m} ( {μ}_{j} ) \\ ( m ∈ {C}_{i} , m \leq n \leq M ) \\ {s}_{n 1}^{m} = \frac{1}{2} {\sum }_{j = \frac{J}{Np} + 1}^{\frac{2 J}{Np}} {ω}_{j} {G}^{m} ( {μ}_{j} ) {P}_{n}^{m} ( {μ}_{j} ) \\ ( m ∈ {C}_{i} , m \leq n \leq M ) \\ … \\ {s}_{n k}^{m} = \frac{1}{2} {\sum }_{j = \frac{kJ}{Np} + 1}^{\frac{J}{Np} ( k + 1 )} {ω}_{j} {G}^{m} ( {μ}_{j} ) {P}_{n}^{m} ( {μ}_{j} ) \\ ( m ∈ {C}_{i} , m \leq n \leq M ) \\ … \\ {s}_{n Np - 1}^{m} = \frac{1}{2} {\sum }_{j = J - \frac{J}{Np} + 1}^{J} {ω}_{j} {G}^{m} ( {μ}_{j} ) {P}_{n}^{m} ( {μ}_{j} ) \\ ( m ∈ {C}_{i} , m \leq n \leq M )\end{matrix} & \end{matrix}$$

By computing all the processes calc(0) to calc(Np−1) and summing the computation results as indicated below, the computation equivalent to the equation (8) is accomplished.

$${s}_{n}^{m} = {\sum }_{k = 0}^{Np - 1} {s}_{nk}^{m} \qquad ( 11 )$$

In practice, since the computation processes calc(0) to calc(Np−1) are executed in sequence, when executing calc(k) subsequently to calc(x), for example, the summation with the computation result obtained up to that time is simultaneously performed as calc(k) as indicated by the following equation (11-1).

$${s}_{nk}^{m} = {s}_{nx}^{m} + \frac{1}{2} {\sum }_{j = \frac{kJ}{Np} + 1}^{\frac{J}{Np} ( k + 1 )} {ω}_{j} {G}^{m} ( {μ}_{j} ) {P}_{n}^{m} ( {μ}_{j} ) \\ ( m ∈ {C}_{i} , m \leq n \leq M ) \qquad calc ( k ) ( 11 \text{-} 1 )$$

When attention is paid to calc(k), the computation region in terms of the latitudinal location j coincides with the computation region of the node k defined by the equation (7) in terms of the latitudinal location j in the Fourier space before the transpose communication. That is, when the reception of the data necessary for the computation of calc(k) (0 k Np−1) is denoted by comm(k) (0 k Np−1), the source of comm(k) is the node k. Then, the data transmission from the node k to the other nodes is completed in a single process.

(b) Method of Overlapping

In the method according to the present embodiment, rather than performing the computation of the equation (8) after the communication of all the data G^{m}(μⱼ) necessary for the computation is completed, the computation of calc(k) is started as the communication of the data G^{m}(μⱼ) (mεCᵢ, ij/Np+1≦j≦J(k+1)/Np) necessary for the computation of calc(k) is completed, without waiting for the entire communication process to complete.

When the computation process is divided in accordance with the method (a), data of given communication process comm(x) is not referred to in the computation of calc(k) (k<x−1, k>x+1). Accordingly, comm(k) (k<x−1, k>x+1) and calc(x) that uses the communication data of comm(x) can be executed independently of each other, so that the communication for calc(k) can be executed before completion of the entire communication process.

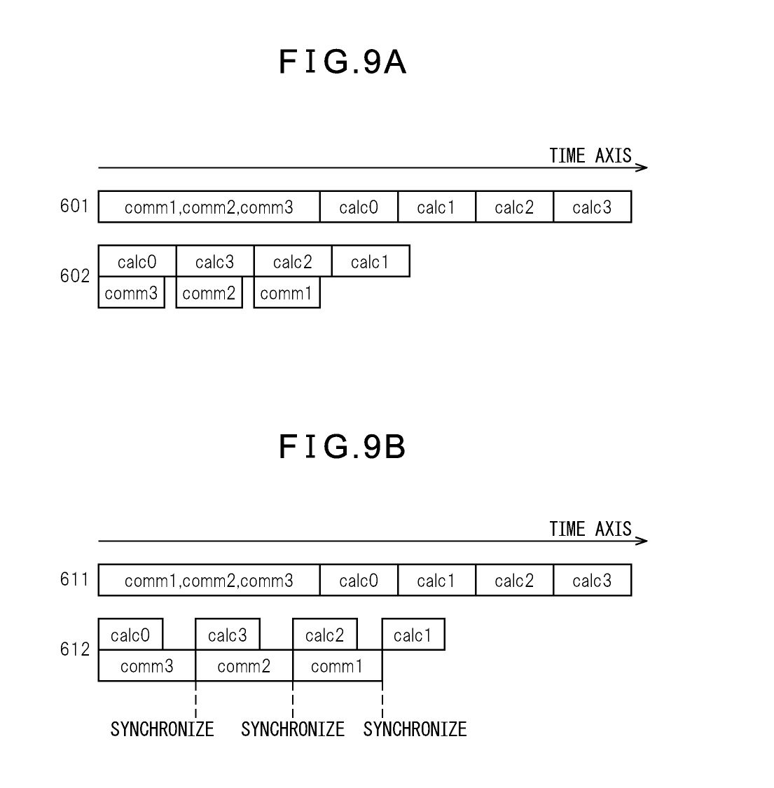

FIGS. 9A and 9B are time charts each illustrating one example of the computation performed at a given node when the Legendre transformation is performed using four nodes. FIG. 9A illustrates the case where the computation time of the Legendre transformation is longer than the communication time required to transmit the result of the Legendre transformation. FIG. 9B illustrates the case where the computation time of the Legendre transformation is shorter than the communication time required to transmit the result of the Legendre transformation.

In the process 601 illustrated in FIG. 9A, all the Legendre transformation processes are executed after the node has received data necessary for all the Legendre transformation processes. On the other hand, in the process 602 illustrated in FIG. 9A, the moment the data necessary for the Legendre transformation for one computation region is received, the Legendre transformation for that computation region is performed. That is, in the process 602, the total processing time of the computation process and communication process becomes shorter than that in the process 601, because the computation process for the next computation region and the process for receiving the data necessary for the next computation region are allowed to proceed in overlapping fashion.

In the process 611 illustrated in FIG. 9B, all the Legendre transformation processes are executed after the node has received data necessary for all the Legendre transformation processes. On the other hand, in the process 612 illustrated in FIG. 9B, the moment the data necessary for the Legendre transformation for one computation region is received, the Legendre transformation for that computation region is performed. Then, in the process 612, in synchronism with the end timing of the receiving process, the node performs processing to start the computation process for the next computation region. Such synchronization can be achieved using MPI_Barrier.

In the process 612 illustrated in FIG. 9B, as in the process 602 illustrated in FIG. 9A, the total processing time of the computation process and communication process becomes shorter than that in the process 611, because the computation process for one computation region and the process for receiving the data necessary for the next computation region are allowed to proceed in overlapping fashion.

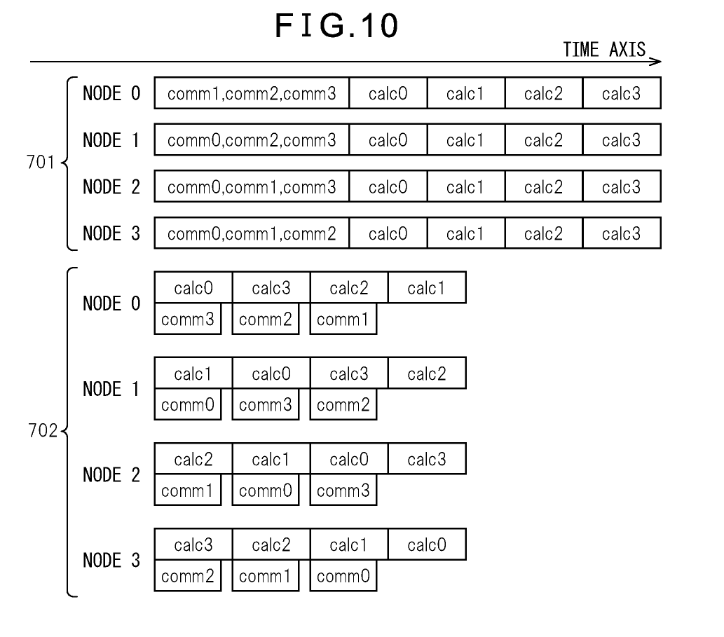

FIG. 10 is a time chart illustrating one example of how the computation processes are performed in parallel at four nodes when the Legendre transformation is performed using the four nodes. In the process 701 illustrated in FIG. 10, all the computation processes are started after the four nodes have completed all the communication processes. On the other hand, in the process 702 illustrated in FIG. 10, after the computation regions according to the equations (5-1) to (5-4) have been assigned to the respective nodes, each node performs the Legendre transformation in accordance with the dividing method indicated by the equation (10) and receives data from the other nodes. As illustrated in FIG. 10, compared with the process 701, the process 702 can reduce the overall processing time of computation and communication.

In the forward transformation of the spherical harmonic function also, by performing the respective processes so that the computation time and the communication time overlap each other as described above, the communication time can be hidden from the total processing time, achieving the parallel processing effect of the parallel computation and thus making possible the effectively utilization of the computing nodes. This serves to reduce the overall processing time.

(c) Enhancement of the Efficiency of Overlapping

In the present embodiment, the execution of the computation process divided by the method (a) is not necessarily started from j=1 but, for any node k, the computation is executed in descending order or ascending order of the computation processes calc(0) to calc(Np−1) in such a manner that calc(k) is executed first. That is, in the case of the descending order, for any node (x), the computation starts with calc(x) and proceeds in the order of calc(x−1), calc(x−2), and so on. After computing calc(0), calc(Np−1) is computed. In the case of the ascending order, for any node (x), the computation starts with calc(x) and proceeds in the order of calc(x+1), calc(x+2), and so on. After computing calc(Np−1), calc(0) is computed.

In the above processing procedure, since calc(k) handles data whose computation result need not be transmitted for the node (k), the communication for the first computation process is not needed. In this way, all the communication processes are executed in overlapping fashion with the computation of the Legendre transformation that requires a large amount of computation, and this serves to enhance the processing efficiency. Further, in each communication phase, all the nodes always perform one transmit or one receive process, so that the communication can be performed effectively by evenly distributing the communication load over the plurality of nodes.

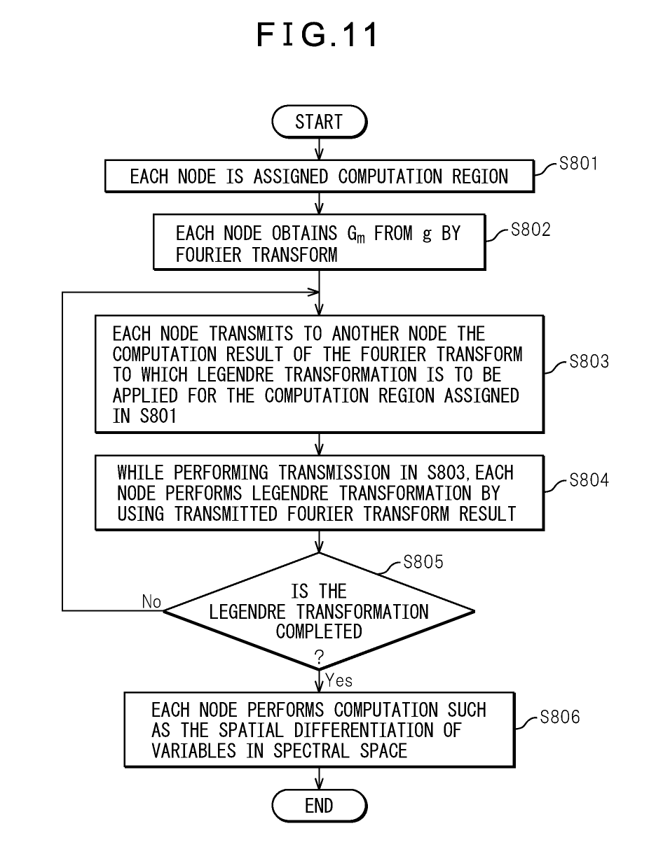

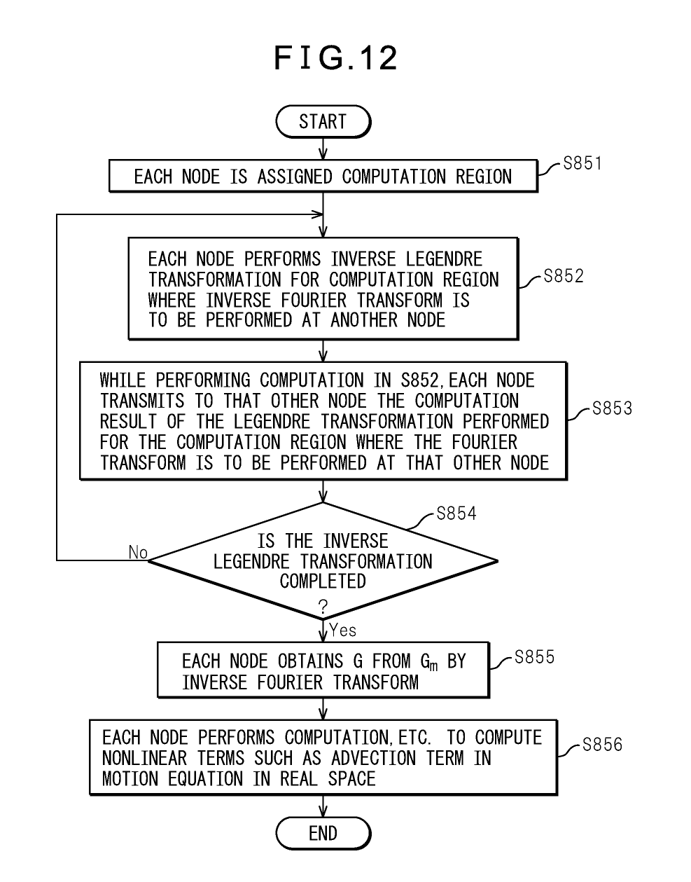

FIG. 11 is a diagram illustrating one example of a numerical analysis process flow that includes the Legendre transformation. FIG. 12 is a diagram illustrating one example of a numerical analysis process flow that includes the inverse Legendre transformation.

The processes illustrated in FIGS. 11 and 12 are repeated every time step until the simulation is completed. That is, the forward and inverse spherical harmonic transforms are performed every time step, moving back and forth between the real space and the spectral space.

In the numerical analysis process flow illustrated in FIG. 11, first the computation region for the Legendre transformation is assigned to each node (S801). More specifically, the computation region for each node to perform numerical computation is stored in the storage area of that node, together with variables for a set of equations such as a motion equation, a continuity equation, an energy equation, a state equation, etc. Such assignment may be made from one of the nodes in FIG. 3A by transferring a file defining the computation region in accordance with the equation (7) to each of the other nodes.

Each node obtains Gm from g by Fourier transform (S802). Each node transmits to another node the computation result of the Fourier transform to which the Legendre transformation is to be applied for the computation region assigned in S801 (S803). While performing the transmission in S803, each node performs the Legendre transformation by using the transmitted Fourier transform result (S804). Each node determines whether the Legendre transformation for the assigned computation region is completed or not (S805).

If the Legendre transformation is not completed yet (No in S805), the process returns to S803. When the Legendre transformation is completed (Yes in S805), each node, after completing the Legendre transformation, performs computation such as the spatial differentiation of variables in spectral space (S806).

In the numerical analysis process flow illustrated in FIG. 12, first the computation region for the inverse Legendre transformation is assigned to each node (S851). More specifically, the computation region for each node to perform numerical computation is stored in the storage area of that node, together with variables for a set of equations such as a motion equation, a continuity equation, an energy equation, a state equation, etc. This step may be performed in step S801. The assignment performed in step S851 may be made from one of the nodes in FIG. 3A by transferring a file defining the computation region in accordance with the equation (9) to each of the other nodes.

Each node performs the inverse Legendre transformation for the computation region where the Fourier transform is to be performed at another node (S852). While performing the computation process in S852 for the region defined by the equation (9), each node transmits to that other node the result of the computation of the associated Legendre function for that computation region (S853). Each node determines whether the Legendre transformation for the assigned computation region is completed or not (S854).

If the Legendre transformation is not completed yet (No in S854), the process returns to S852. When the Legendre transformation is completed (Yes in S854), each node performs computation, etc., which include the computation of nonlinear terms, such as an advection term in the motion equation in real space.

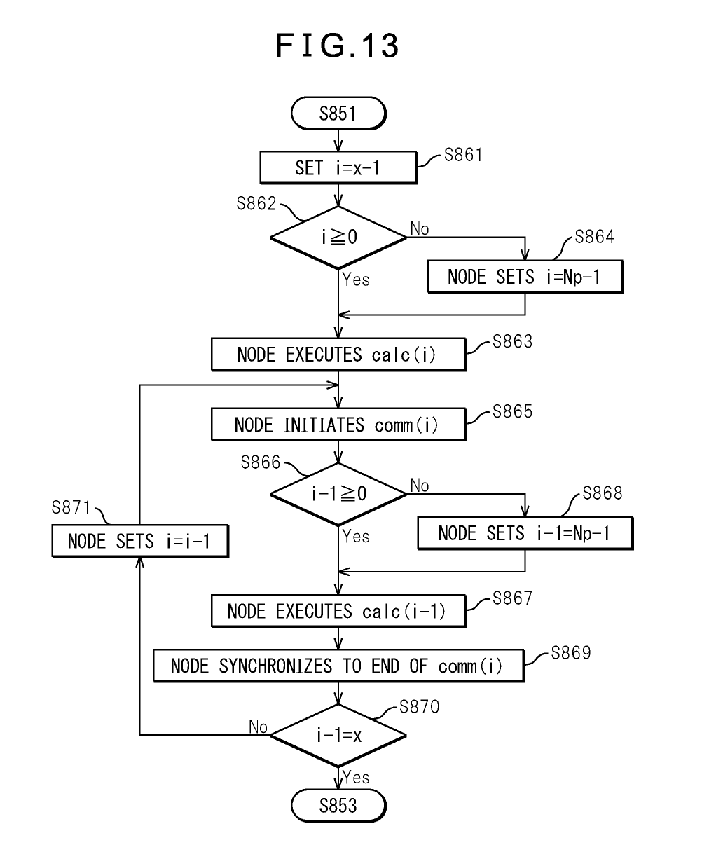

FIG. 13 is a diagram illustrating one example of a process flow for the inverse Legendre transformation illustrated in FIG. 6B.

The numerical analysis process flow illustrated in FIG. 13 defines the process flow at node x. The node number represented by, i, for identifying the destination node to which the result of the inverse Legendre transformation is to be transmitted is set to x−1 (S861). Here, x is a natural number, and the maximum value of x is equal to the number (Np) of nodes minus 1. Next, each node determines whether i≧0 is satisfied or not (S862). If i≧0 is not satisfied (No in S862), the node number represented by, i, is set to Np−1 (S864). If i≧0 is satisfied (Yes in S862), the node executes calc(i) (S863). The node initiates comm(i) (S865). More specifically, the node transmits the computation result of calc(i) to the destination node i.

Next, each node determines whether i−1≧0 is satisfied or not (S866). If i−1≧0 is not satisfied (No in S866), the node number represented by, i, is set to Np−1 (S868). If i−1≧0 is satisfied (Yes in S866), the node executes calc(i−1) (S867). With the node synchronized to the transmission end timing of comm(i) (S869), each node determines whether i−1=x is satisfied or not (S870). If i−1=x is not satisfied (No in S870), the node number represented by, i, is set to i−1 (S871). If i−1=x is satisfied (Yes in S870), the node performs the inverse Fourier transform indicated in step S853 of FIG. 12.

After performing step S871, the node again initiates the communication process comm(i) (S865). If i−1≧0 is not satisfied in S866, the node number represented by, i, is set to Np−1, so that the computation of the associated Legendre function is performed for the computation region for which the result of the computation is to be transmitted to the node of the largest node number, and the process is repeated in descending order.

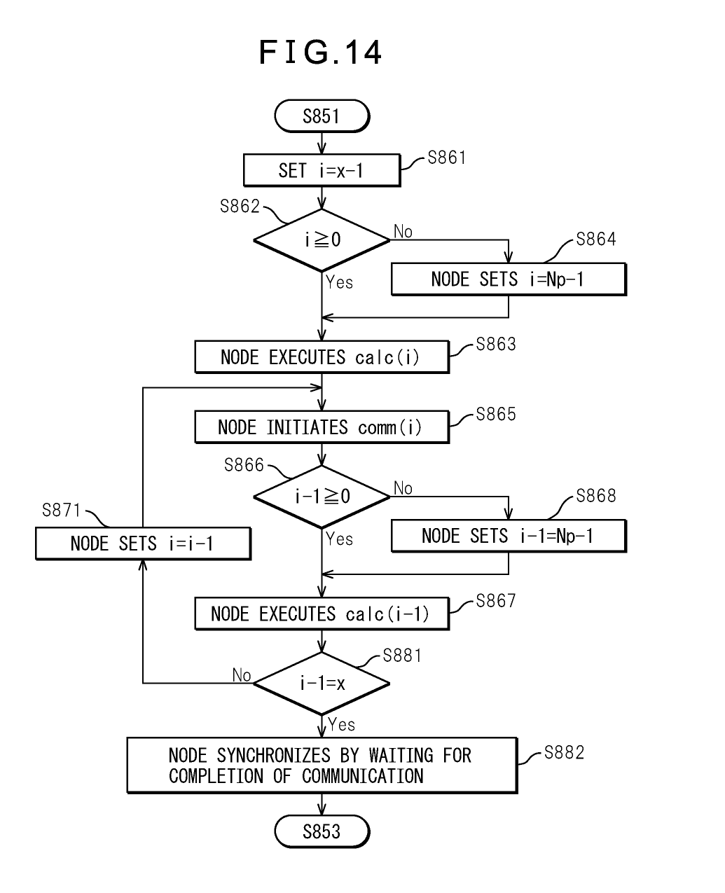

FIG. 14 is a diagram illustrating one example of a process flow for the inverse Legendre transformation illustrated in FIG. 6C.

In the numerical analysis process flow illustrated in FIG. 14, steps S861 to S869 and S871 are the same as those described with reference to FIG. 13, and therefore, these steps will not be further described herein. In step S871, unlike step S870, i is decremented without performing synchronization. This means that the Legendre transformation is performed without waiting for the completion of the ongoing communication process. Finally, in step S882, synchronization is performed upon completion of all the communication processes, and after that, the inverse Fourier transform indicated in step S853 of FIG. 12 is performed.

The above equation (1) has been given for the spherical harmonic function of the latitude and longitude on the sphere, but it can also be applied to three-dimensional computation that includes the height dimension in addition to the latitude and longitude. For example, in the three-dimensional case, the spherical harmonic function is given by the following equation (12).

$$g ( {r}_{i} , {λ}_{k} , {μ}_{j} ) = {\sum }_{m = - M}^{M} {\sum }_{n = \vert m \vert}^{N ( m )} {s}_{n}^{m} ( {r}_{i} ) {Y}_{n}^{m} ( {λ}_{k} , {μ}_{j} ) \\ ( i = 1 , 2 , … , Nr , k = 0 , 1 , … , K , j = 1 , 2 , … , J ) \qquad ( 12 )$$

Here, ri represents grid points in the altitudinal direction, and the number of grid points is denoted by Nr.

The above spherical harmonic transform can also be applied when performing the spherical harmonic transform on a plurality of variables at the same time. An example is a spherical harmonic transform such as given by the following equation (13).

$$g ( {v}_{i} , {λ}_{k} , {μ}_{j} ) = {\sum }_{m = - M}^{M} {\sum }_{n = \vert m \vert}^{N ( m )} {s}_{n}^{m} ( {v}_{i} ) {Y}_{n}^{m} ( {λ}_{k} , {μ}_{j} ) \\ ( i = 1 , 2 , … , Nvar , k = 0 , 1 , … , K , j = 1 , 2 , … , J ) \qquad ( 13 )$$

Here, vi represents one variable, and the total number of variables is denoted by Nvar.

Further, the above spherical harmonic transform can also be applied to two-dimensional parallelization in which the process is divided not only in the latitudinal or longitudinal direction but also in the height direction. When the number of divisions in the altitudinal direction is denoted by Q, the spherical harmonic transform for the x-th portion of the divided data, for example, is given by the following equation (14). The following equation can be solved by dividing it into P processes in the latitudinal and longitudinal directions. In this case, the total number of nodes used is P×Q.

$$g ( {r}_{i} , {λ}_{k} , {μ}_{j} ) = {\sum }_{m = - M}^{M} {\sum }_{n = \vert m \vert}^{N ( m )} {s}_{n}^{m} ( {r}_{i} ) {Y}_{n}^{m} ( {λ}_{k} , {μ}_{j} ) \\ ( \begin{matrix}i = \frac{xNr}{Q} + 1 , \frac{xNr}{Q} + 2 , … , \frac{2 xNr}{Q} , \\ k = 0 , 1 , … , K , j = 1 , 2 , … , J\end{matrix} ) \qquad ( 14 )$$

Here, ri represents grid points in the altitudinal direction, and the number of grid points is denoted by Nr.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A parallel computing system for performing a simulation of a sphere by using a spherical harmonic function, and comprises a plurality of computing nodes interconnected with each other via a communication path, each of the plurality of computing nodes comprising:
a storage unit that stores spectral data obtained by dividing spectral space data into a plurality of data elements on the basis of longitudinal wavenumber;
a computation unit that performs inverse Legendre transformation for a computation region divided in a latitudinal direction on the sphere and thereby transforms each of the spectral data elements to Fourier coefficient data; and
a communication unit that transmits the Fourier coefficient data, obtained through the transformation performed by the computation unit, to another computing node via the communication path after the inverse Legendre transformation for the next computation region divided in the latitudinal direction on the sphere has been started by the computation unit.

2. The parallel computing system according to claim 1, wherein the computation unit performs the transformation to the Fourier coefficient data by dividing the transformation in the latitudinal direction for each computation region where the computing node to which the communication unit transmits the Fourier coefficient data is the same.

3. The parallel computing system according to claim 1, wherein when the computation unit performs the transformation to the Fourier coefficient data, the inverse Legendre transformation for the latitudinally divided computation region where the computing node to which the communication unit transmits the Fourier coefficient data is the transmitting computing node itself.

4. The parallel computing system according to claim 2, wherein when the computation unit performs the transformation to the Fourier coefficient data by dividing the transformation in the latitudinal direction for each computation region where the computing node to which the communication unit transmits the Fourier coefficient data is the same, the computation unit performs the transformation to the Fourier coefficient data and transmitting the Fourier coefficient data via the communication path for each of the latitudinally divided computation regions in descending order or ascending order of the latitudinal locations thereof.

5. A control method for a parallel computing system for performing a simulation of a sphere by using a spherical harmonic function, and comprises a plurality of computing nodes interconnecting with each other via a communication path, the control method comprising:
performing inverse Legendre transformation by a computation unit in each of the computing nodes for a computation region divided in a latitudinal direction on the sphere and thereby transforms each of spectral data elements obtained by dividing spectral space data into a plurality of data elements on the basis of longitudinal wavenumber to Fourier coefficient data;
performing the inverse Legendre transformation by the computation unit in each of the computing nodes for the next computation region divided in the latitudinal direction on the sphere; and
transmitting the Fourier coefficient data to another computing node by a communication unit in each of the computing nodes via the communication path after the inverse Legendre transformation for that next computation region divided in the latitudinal direction on the sphere has been started.

6. The control method according to claim 5 further comprising performing the transformation to the Fourier coefficient data by dividing the transformation in the latitudinal direction by the computation unit for each computation region where the computing node to which the communication unit transmits the Fourier coefficient data is the same.

7. The control method according to claim 5 further comprising performing the inverse Legendre transformation by the computation unit for the latitudinally divided computation region where the computing node to which the communication unit transmits the Fourier coefficient data is the transmitting computing node itself.

8. The control method according to claim 6 further comprising performing the transformation to the Fourier coefficient data and transmitting the Fourier coefficient data via the communication path by the computation unit for each of the latitudinally divided computation regions in descending order or ascending order of the latitudinal locations thereof, when the computation unit in each of the computing nodes performs the transformation to the Fourier coefficient data by dividing the transformation in the latitudinal direction for each computation region where the computing node to which the communication unit transmits the Fourier coefficient data is the same.

9. A computer readable storage medium storing a control program for causing a parallel computer comprising a plurality of computing nodes interconnecting with each other via a communication path to perform simulation of a sphere by using a spherical harmonic function, the control program causes each of the plurality of computing node execute:
performing inverse Legendre transformation for a computation region divided in a latitudinal direction on the sphere and thereby to transform each of spectral data elements obtained by dividing spectral space data into a plurality of data elements on the basis of longitudinal wavenumber to Fourier coefficient data;
performing the inverse Legendre transformation for the next computation region divided in the latitudinal direction on the sphere; and
transmitting the Fourier coefficient data to another computing node via the communication path after the inverse Legendre transformation for that next computation region divided in the latitudinal direction on the sphere has been started.

10. The computer readable storage medium according to claim 9, wherein the control program further causes each of the plurality of the computing nodes execute:
performing the transformation to the Fourier coefficient data by dividing the transformation in the latitudinal direction for each computation region where the computing node to which the communication unit transmits the Fourier coefficient data is the same.

11. The computer readable storage medium according to claim 9, wherein the control program further causes each of the plurality of the computing nodes execute performing the inverse Legendre transformation for the latitudinally divided computation region where the computing node to which the communication unit transmits the Fourier coefficient data is the transmitting computing node itself, there being therefore no need to transmit the Fourier coefficient data via the communication path, when the computation unit in each of the computing nodes performs the transformation to the Fourier coefficient data.

12. The computer readable storage medium according to claim 9, wherein the control program causes each of the plurality of the computing nodes to execute performing the transformation to the Fourier coefficient data and transmitting the Fourier coefficient data via the communication path for each of the latitudinally divided computation regions in descending order or ascending order of the latitudinal locations thereof, when the computation unit in each of the computing nodes performs the transformation to the Fourier coefficient data by dividing the transformation in the latitudinal direction for each computation region where the computing node to which the communication unit transmits the Fourier coefficient data is the same.

13. A parallel computing system for performing a simulation of a sphere by using a spherical harmonic function, comprising a plurality of computing nodes interconnected with each other via a communication path, each of the plurality of computing nodes comprising:
a storage unit that stores Fourier coefficient data obtained by dividing Fourier space data into a plurality of data elements on the basis of longitudinal wavenumber or in a longitudinal direction;
a computation unit that transforms the Fourier coefficient data to spectral data by performing Legendre transformation for each of the Fourier coefficient data elements; and
a communication unit that transmits the Fourier coefficient data, to be used for the Legendre transformation by the computation unit, at the same time that the computation unit starts the Legendre transformation of previously received Fourier coefficient data.

14. The parallel computing system according to claim 13, wherein:
each of the plurality of computing nodes performs Legendre transformation for the received Fourier coefficient data and thereby transforms each of the Fourier coefficient data to spectral data elements; and,
one of the plurality of computing nodes transforms the other computing nodes.

15. The parallel computing system according to claim 13, wherein
each of the plurality of computing nodes transmits the Fourier coefficient data, and
each of the plurality of computing nodes starts to perform Legendre transformation for the Fourier coefficient data when the computing node to which the communication unit transmits the Fourier coefficient data is the computing node itself.

16. The parallel computing system according to claim 13, wherein
each of the plurality of computing nodes transmits the Fourier coefficient data, and
each of the plurality of computing nodes performs Legendre transformation for the received Fourier coefficient data and thereby transforms each of the Fourier coefficient data to spectral data elements wherein the computation unit performs the Legendre transformation and transmitting the Fourier coefficient data in descending order or ascending order of the latitudinal locations thereof.

17. A control method for a parallel computing system for performing a simulation of a sphere by using a spherical harmonic function, and comprises a plurality of computing nodes interconnecting with each other via a communication path, the control method comprising:
transforming the Fourier coefficient data to spectral data by performing Legendre transformation by a computation unit in each of the computing nodes for each of the Fourier coefficient data elements; and
transmitting to be used for the Legendre transformation by the computation unit in each of the computing nodes, at the same time that the computation unit starts the Legendre transformation of previously received Fourier coefficient data.

18. A computer readable storage medium storing a control program for causing a parallel computer comprises a plurality of computing nodes interconnecting with each other via a communication path to perform simulation of a sphere by using a spherical harmonic function, the program causes each of the plurality of computing node execute:
transforming the Fourier coefficient data to spectral data by performing Legendre transformation by a computation unit for each of the Fourier coefficient data elements; and
transmitting the Fourier coefficient data to be used for the Legendre transformation by the computation unit by a communication unit at the same time that the computation unit starts the Legendre transformation of previously received Fourier coefficient data.
